(19) United States
(12) Patent Application Publication
(10) Pub. No.: US 2016/0315456 A1
(43) Pub. Date: Oct. 27, 2016

(54) Mounting Holder for a Line Bushing and Assembly Having a Mounting Holder

(71) Applicant: HILTI AKTIENGESELLSCHAFT, Schaan (LI)

(72) Inventor: Christian FOERG, Lamerdingen (DE)

(73) Assignee: Hilti Aktiengesellschaft, Schaan (LI)

(21) Appl. No.: 15/030,838

(22) PCT Filed: Oct. 20, 2014
(86) PCT No.: PCT/EP2014/072401

§ 371 Date: Apr. 20, 2016

(30) Foreign Application Priority Data
Oct. 21, 2013 (EP) 13189540.1

(51) Int. Cl. H02G 3/22

(52) U.S. Cl. CPC H02G 3/22

(57) ABSTRACT

A mounting holder for a line bushing, by which the line bushing can be incorporated into a component, in particular a wall or a ceiling, is disclosed. The mounting holder has a circumferential wall which is closed at the circumference and has a flange section for fastening to a formwork projecting outward from its first axial end and has an insertion opening which extends axially through the mounting holder for a tubular line bushing emerging from its second, opposite, axial end. A first fastening structure for engaging on an outer circumference of the line bushing projects into the insertion opening.

This application claims the priority of International Application No. PCT/EP20141072401, filed Oct. 20, 2014, and European Patent Document No. 13189540.1, filed Oct. 21, 2013, the disclosures of which are expressly incorporated by reference herein.

### BACKGROUND AND SUMMARY OF THE INVENTION

The invention relates to a mounting holder for a line bushing and an assembly of a mounting holder and a line bushing.

Line bushings are used to pass cables or piping through components such as ceilings or walls. An essential aspect thereby is fire protection, which is guaranteed, e.g., by intumescent material contained in the line bushing. These types of line bushings are often structured in a complex manner and are either inserted into openings in the component that are created subsequently or incorporated directly into the component during fabrication thereof. Such a line bushing is described in DE 102006035475 A1 for example.

The object of the invention is to create a possibility with which a line bushing can be incorporated into a component in a simple manner without the line bushing itself having to be designed especially for the incorporation process.

According to the invention, a mounting holder for a line bushing is provided for this purpose, by means of which the line bushing can be incorporated into a component, in particular a wall or a ceiling. The mounting holder comprises a circumferential wall which is closed at the circumference and a flange section for fastening to a formwork projecting outward from its first axial end. The flange section defines a plane that is aligned perpendicularly to the center axis of the circumferential wall. In the case of a round or oval cross-section of the line bushing, “projecting outward” signifies that the flange section projects radially outward.

In the case of a rectangular cross-section, the flange region extends outwardly starting from the center axis of the circumferential wall, i.e., starting from the center axis of the circumferential wall away from the circumferential wall. An insertion opening, which extends axially through the mounting holder, for a line bushing, emerges from the second, opposite, axial end of the circumferential wall. A first fastening structure for engaging on an outer circumference of the line bushing projects into the insertion opening. The mounting holder according to the invention also makes it possible to incorporate a component into a line bushing without structural changes, which component is not explicitly designed therefor, in that the line bushing is inserted into the mounting holder. The line bushing is able to be fastened in a simple manner via the mounting holder for example to a formwork, which is being used for casting the component.

The shape of the insertion opening is not limited thereby. In general, it is adapted to a tubular, i.e., round line bushing. Alternatively, the insertion opening can also be adapted to line bushings having different cross-sectional shapes, for instance rectangular, in particular square, for a square tube.

The flange section can comprise openings, via which the mounting holder can be fastened to the formwork. As a result, no contact between the formwork and the line bushing is required. The openings are preferably provided in the vicinity of the edge of the flange section, for example in corners of a quadrangular flange section so that the flange section can be nailed on a formwork in a simple way.

An inwardly extending cover section, i.e., in the direction of the center axis of the circumferential wall or of the line bushing, is arranged on the second end of the circumferential wall, in which the insertion opening is provided.

The entire mounting holder can be fabricated simply as a cast part, thermoformed part or stamped part.

In a first embodiment of an assembly of a mounting holder, as described above, and a line bushing, the first fastening structure is formed by a slide seal ring known to a person skilled in the art.

An advantage of using a slide seal ring is that even line bushings that do not have a round cross-section, such as those with a rectangular cross-section, can be used in a simple manner. Then, the insertion opening is of course adapted to the cross-section of the line bushing.

In the case of an alternative assembly of a mounting holder, as described above, and a line bushing, a second fastening structure is provided according to the invention on the outer circumference of the line bushing, which fastening structure can engage in the first fastening structure. The first and the second fastening structures are configured such that they allow an axial adjustment of the line bushing relative to the mounting holder, but form a substantially tight connection for a casting compound, in particular concrete. The axial adjustment possibility via the fastening structures makes it possible in a simple manner to adapt the length of the line bushing protruding beyond the mounting holder to the respective circumstances, for example the thickness of the component.

The engagement of the fastening structures is preferably the only contact between the mounting holder and the line bushing.

According to a first preferred embodiment, the first and the second fastening structures are formed by complementary latching elements, which allow an axial displacement and locking into place of the line bushing with respect to the mounting holder.

In this case as well, the first fastening structure can be formed by a special shape of the edge of the insertion opening, which engages in the latching elements, for example in the form of prongs or steps, in the outer wall of the line bushing.

In this case, the cover section or the edge of the insertion opening is preferably configured to be so flexible that the latching elements of the first fastening structure slide over the latching elements of the second fastening structure when a nondestructive force is applied.

The latching elements on the outer circumference of the line bushing are preferably formed by circumferential structures in order to make a seal against the casting compound possible in a simple manner.

An advantage of using complementary latching elements is that even line bushings that do not have a round cross-section can he used in a simple manner. Then, the insertion opening is of course adapted to the cross-section of the line bushing.

In a second preferred embodiment, the first and the second fastening structures are formed by a thread. The line bushing is screwed into the mounting holder to the desired length, which guarantees a continuously variable length adjustment and a secure connection at the same time, which prevents an unintentional axial displacement.

It can be sufficient to form the first fastening structure only by a single thread pitch. This can simply be impressed or shaped in the edge of the insertion opening, which can take place in a work step during the production of the mounting holder for example during stamping, thermoforming or injection molding.

The fastening structures are preferably so impervious to the casting compound that no additional sealing need be undertaken, which accelerates processing.

However, a seal can also be provided between the mounting holder and the line bushing, for example a film seal, which can he formed on the mounting holder in a two-component injection molding process. Thus, it is possible to establish a connection that is impervious to concrete in a simple manner especially when using latching elements for the first and second fastening structures.

The second fastening structure advantageously extends substantially over the entire length of the line bushing so that a large adjustment length can be achieved.

In addition, a cover for sealing the axial end of the line bushing can be provided, which is not accommodated in the mounting holder in order to prevent a penetration of concrete.

In a possible variant, both axial ends of the line bushing are each accommodated in a separate mounting holder. One of the mounting holders is used, e.g., for fastening to the formwork, whereas the second mounting holder is used for example as an extension for the line bushing in the case of thicker components.

A cover can also be provided here, which is able to seal one of the mounting holders, preferably the one that is not fastened to the formwork, so that it is impervious to concrete.

An inner side of the circumferential wall of the mounting device is preferably spaced apart from the outer wall of the line bushing starting from the center axis of the line bushing. In this way, the outer circumference of the line bushing is accessible after incorporation into the component. This is advantageous above all if the line bushing features adjustable elements, which are arranged on its outer circumference.

For mounting on a trapezoidal sheet for example, a compensating element can be provided that can be connected to the flange section of the mounting holder so that it extends into the extension of the flange section and makes a fastening of the flange section at a greater distance from the line bushing possible, for example on the next elevation of the trapezoidal sheet.

The invention will be described in greater detail in the following based on several exemplary embodiments making reference to the enclosed drawings.

### BRIEF DESCRIPTION OF THE DRAWINGS

FIG. 1 is a schematic sectional view through an assembly according to the invention of a mounting holder and line bushing;

FIG. 2 is a schematic perspective representation of the mounting holder from FIG. 1;

FIG. 3 is a schematic perspective representation of the assembly from FIG. 1;

FIG. 4 is a schematic perspective representation of the assembly from FIG. 1, partially incorporated into a component;

FIG. 5 is an enlarged section from FIG. 4;

FIG. 6 is a schematic sectional view of an assembly according to the invention with a mounting holder, a line bushing and a cover, incorporated into a component;

FIG. 7 is a schematic sectional view of an assembly according to the invention with two mounting holders and a line bushing, incorporated into a component; and

FIG. 8 is a schematic sectional view of an assembly according to the invention with a mounting holder, a line bushing, a cover and a compensating element.

### DETAILED DESCRIPTION OF THE DRAWINGS

FIG. 1 shows an assembly 10 of a mounting holder 12 and a tubular line bushing 14 inserted therein.

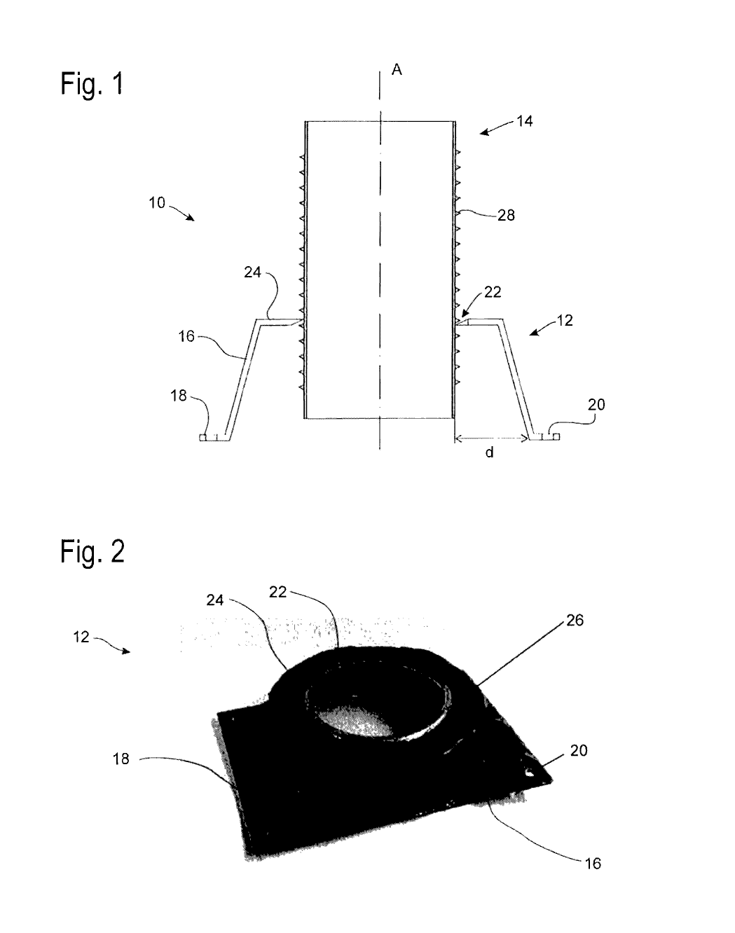

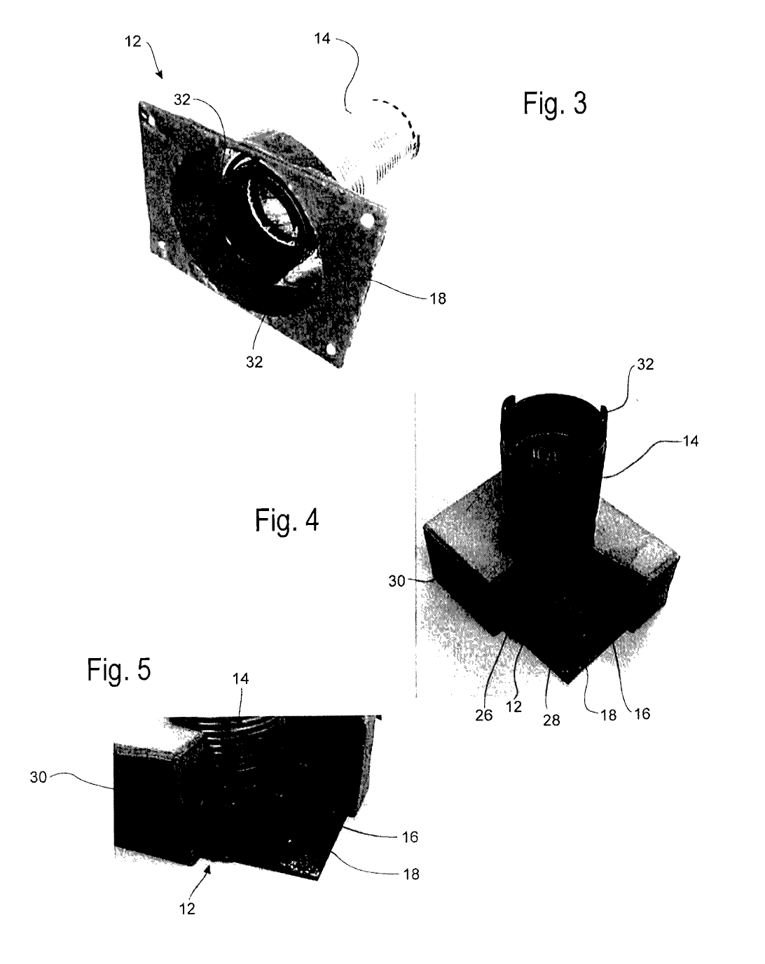

As is clearly evident in FIG. 2, the mounting holder 12 has a closed circumferential wall 16, which merges into a flange section 18 that projects radially outwardly on a first axial end. The flange section 18 in this example is configured to be quadrangular, wherein an opening 20 is provided in each of the corners, via which the mounting holder 12 can be fastened to a formwork.

Configured on the second, opposite axial end of the circumferential wall 16 is an insertion opening 22, which in this case is arranged centered in a cover section 24 running radially inwardly from the axial end of the circumferential wall 16.

Integrated into the edge of the insertion opening 22 is a first fastening structure 26, which projects into the insertion opening 22.

In the case of the embodiment shown here, the first fastening structure 26 is a thread, more precisely, a single thread pitch.

The line bushing 14 is a prefabricated tubular component, which has one or more cavities in the interior thereof for the passage of lines such as cables or piping and which has a second fastening structure 28 on the closed outer circumference thereof. In the depicted example, the second fastening structure 28 is configured in the form of a thread running over substantially the entire length of the line bushing 14.

The line bushing 14 can be screwed into the mounting holder 12 by means of the thread of the fastening structures 26, 28. This naturally yields a continuously variable adjustability in axial direction A so that the line bushing 14 can be fixed to the mounting holder 12 in any axial position relative to the mounting holder.

The circumferential wall 16 of the mounting holder 12 is configured to he conical in this example, wherein the opening angle in the figures is directed downward toward the flange section 18. This and the cover section 24 produce a distance d between the circumferential wall 16 and the outer wall of the line bushing 14. Therefore, the outer surface of the line bushing 14 is freely accessible on the axial end thereof that is inserted into the mounting holder 12 even after incorporation into a component 30.

In this case, the line bushing 14 has functional elements 32 on both axial ends thereof, which can he twisted for example with respect to the rest of the line bushing 14.

The line bushing 14 in this case is configured to be fire resistant. The mounting holder 12 could also be provided with a fire protection material, for example in the form of a coating.

In order to incorporate the line hushing 14 into the component 30, for example a wall or a ceiling, first of all the line bushing 14 is screwed into the insertion opening 22 of the mounting holder 12. The length of the line bushing 14 protruding beyond the insertion opening 22 is determined for example by the thickness of the component 30.

The connection between the outer circumference of the line bushing 14 and the edge of the insertion opening 22 is largely impervious to concrete because of the engagement of the fastening structures 26, 28. It is also possible (not shown here) to additionally attach a seal to the edge of the insertion opening 22, for example in the form of a film seal that is cast on.

The assembly of the line bushing 14 and mounting holder 12 is fastened to a formwork (not shown) via the openings 20 in the flange section 18. Then the component 30 is cast, wherein the line bushing 14 is normally completely embedded in the component 30 and the mounting holder 12 at least in sections. This state is depicted FIGS. 4 and 5.

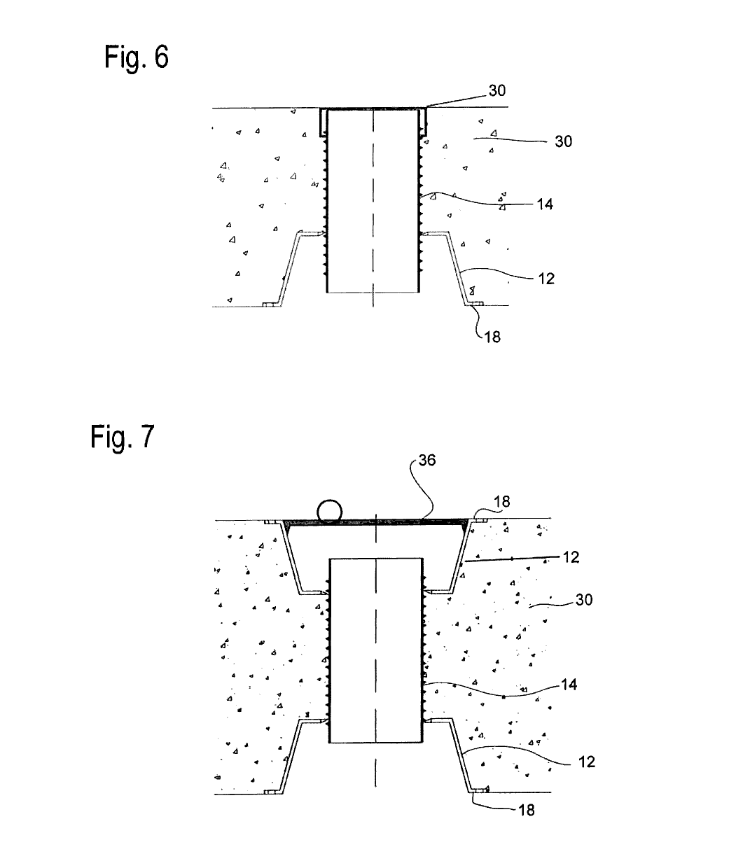

To adjust to the thickness of the component 30, in the first case, which is depicted. in FIG. 6, the line bushing 14 is screwed into the mounting holder 12 so far that the free end of the line bushing 14 terminates flush with the subsequent surface of the component 30.

Of course, the line bushing 14 could also project over the finished component 30, if this is desired.

In this example, the free end of the line bushing 14 is sealed with a cover 34, for instance a plastic cap or an adhesive tape, which prevents a penetration of concrete when casting the component 30.

FIG. 7 shows a second possibility for mounting, in particular for component thicknesses that exceed the length of the line bushing 14.

In this case, a mounting holder 12 is arranged on each axial end of the line bushing 14. The assembly 10 is fastened as described to a formwork with the lower mounting holder 12 in FIG. 7 and thereby positioned with respect to the component 30 to be cast. The mounting holder 12 that is attached to the upper end in FIG. 7 serves as an axial extension and, in the depicted case, is screwed onto the other axial end of the line bushing 14 far enough that the flange section 18 of the mounting holder 12 terminates flush with the upper side of the component 30 after casting.

In order to prevent concrete from penetrating into the upper mounting holder 12, a cover 36 is fitted here in the inner opening of the mounting holder 12 within the flange section 18, which has a loop for easy removal.

This design can naturally be used also for thinner components 30, if a radial distance from the outer circumference of the line bushing 14 is desired on both ends of the line bushing 14 after casting the component 30, for example to operate the functional elements 32.

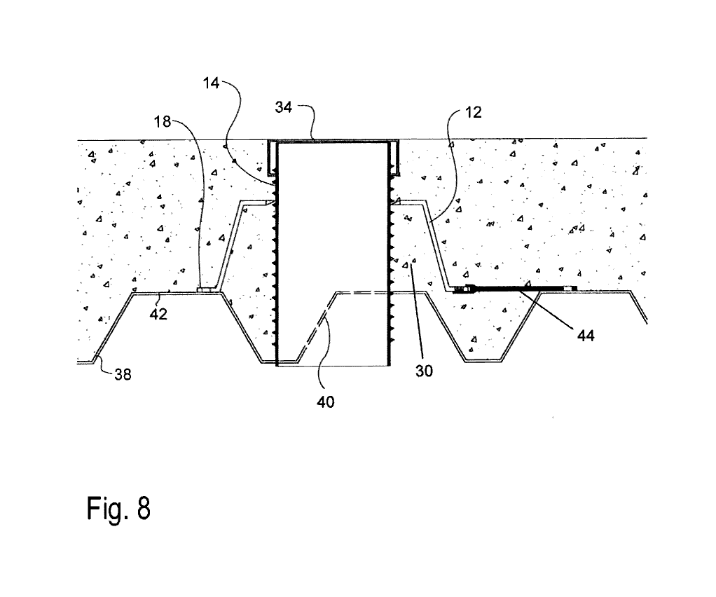

FIG. 8 shows a mounting on a trapezoidal sheet 38. A suitable opening 40 for the line bushing 14 is cut into the trapezoidal sheet 38, through which the line bushing projects up to the desired length. Part of the flange section 18 of the mounting holder 12 rests on one of the elevations 42 of the trapezoidal sheet 38. In the depicted example, the distance of the elevations 42 of the trapezoidal sheet 38 is great enough that the opposite end of the flange section 18 hangs in the air, i.e., it does not reach an elevation 42. Therefore, a compensating element 44 is provided in this case, which is connected to the flange section 18 and extends to the next elevation 42 of the trapezoidal sheet 38 as an extension of the flange section 18. In this way, the mounting holder 12 can be firmly connected to the trapezoidal sheet 38 on two opposite sides of the flange section 18.

The connection between the compensating element 44 and the flange section 18 is accomplished in this case in the form of a snap connection, which engages in one or more of the openings 20 in the flange section 18. The fastening of the compensating element 44 to the flange section 18 can of course be accomplished in any appropriate means.

In the case of this mounting type, concrete runs under the mounting holder 12, which does not constitute a problem, however, because the line bushing 14 is sealed via opening 40 in the trapezoidal sheet 38.

The upper end of the line bushing 14 in FIG. 8 is sealed with a cover 34 like in FIG. 6 in order to prevent a penetration of concrete.

In a second embodiment (not shown), the first and the second fastening structures are not formed by a thread, but by complementary latching elements.

In this case, it is possible to implement the inner edge of the insertion opening as a latching edge, while successive latching elements are configured on the outer circumference of the line bushing in the axial direction, for example in the form of protrusions that project radially outwardly.

The edge of the insertion opening and/or the outer wall of the line bushing are configured to be so flexible that a displacement of the line bushing relative to the mounting holder is possible with moderate force in order to lock the bushing in the desired axial position in the insertion opening.

In the depicted examples, the cross-section of the line bushing 14 is round. However, if a latching connection is used for the first and second fastening structures 26, 28, any arbitrary non-circular cross-section can also be used.

1-14. (canceled)

15. An apparatus for holding a line bushing, wherein the line bushing is incorporatable into a component by the apparatus, comprising:
a mounting holder, wherein the mounting holder has a circumferential wall which is closed at a circumference of the circumferential wall and has a flange section, for fastening to a formwork, that projects outwardly from a first axial end of the circumferential wall and has an insertion opening, for the line bushing, that extends axially through the mounting holder from a second axial end of the circumferential wall, wherein the first axial end is opposite from the second axial end;
wherein a first fastening structure, for engaging on an outer circumference of the line bushing, projects into the insertion opening.

16. The apparatus according to claim 15, wherein the flange section has openings and/or wherein an inwardly extending cover section is disposed on the second axial end of the circumferential wall.

17. An assembly, comprising:
a first mounting holder; and
a line bushing;
wherein the first mounting holder has a circumferential wall which is closed at a circumference of the circumferential wall and has a flange section, for fastening to a formwork, that projects outwardly from a first axial end of the circumferential wall and has an insertion opening that extends axially through the first mounting holder from a second axial end of the circumferential wall, wherein the first axial end is opposite from the second axial end, and wherein the line bushing is disposed through the insertion opening;
wherein a first fastening structure of the first mounting holder that projects into the insertion opening engages on an outer circumference of the line bushing

18. The assembly according to claim 17, wherein the first fastening structure is a slide seal ring.

19. The assembly according to claim 17, wherein a second fastening structure is disposed on the outer circumference of the line bushing, wherein the second fastening structure engages with the first fastening structure, and wherein the first fastening structure and the second fastening structure allow for an axial adjustment of the line bushing relative to the first mounting holder and form a substantially tight connection for a casting compound.

20. The assembly according to claim 19, wherein the first fastening structure and the second fastening structure are complementary latching elements which provide for an axial displacement and locking into place of the line bushing in the first mounting holder.

21. The assembly according to claim 19, wherein the first fastening structure and the second fastening structure are threads.

22. The assembly according to claim 21, wherein the first fastening structure is a single thread pitch.

23. The assembly according to claim 17, wherein a seal is disposed between the first mounting holder and the line bushing.

24. The assembly according to claim 19, wherein the second fastening structure extends substantially over an entire length of the line bushing.

25. The assembly according to claim 17, further comprising a cover, wherein the cover seals an axial end of the line bushing and wherein the cover is not disposed in the first mounting holder.

26. The assembly according to claim 17, further comprising a second mounting holder, wherein axial ends of the line bushing are respectively received in the first mounting holder and the second mounting holder.

27. The assembly according to claim 26, further comprising a cover, wherein the cover seals one of the first mounting holder and the second mounting holder.

28. The assembly according to claim 17, wherein an inner side of the circumferential wall of the first mounting holder is spaced apart from an outer wall of the line bushing.

29. The assembly according to claim 17, further comprising a compensating element which is connected to the flange section.
